(19) United States
(12) Patent Application Publication
(10) Pub. No.: US 2011/0122207 A1
(43) Pub. Date: May 26, 2011

(54) INK-JET HEAD

(75) Inventors: Hyun-Ho SHIN, Suwon-si (KR); Chung-Mo Yang, Ansan-si (KR); Yoon-Sok Park, Suwon-si (KR); Suk-Ho Song, Ansan-si (KR); Chang-Sung Park, Suwon-si (KR); Won-Chul Sim, Sungnam-si (KR)

(73) Assignee: Samsung Electro-Mechanics Co., Ltd.

(21) Appl. No.: 12/765,545

(22) Filed: Apr. 22, 2010

(30) Foreign Application Priority Data
Nov. 26, 2009 (KR) 10-2009-0115210

(51) Int. Cl. B41J 2/175

(52) U.S. Cl. 347/85

(57) ABSTRACT

An ink-jet head is disclosed. The ink-jet head in accordance with an embodiment of the present invention is equipped with a plurality of jetting cells, each of which ejects ink. Each of the plurality of jetting cells is connected to a common reservoir supplying the ink, and a pillar is formed inside the common reservoir, in which the pillar supports an upper surface of the common reservoir by being extended from a lower surface to the upper surface of the common reservoir and the pillar disperses a pressure wave transferred inside the common reservoir.

### CROSS-REFERENCE TO RELATED APPLICATIONS

This application claims the benefit of Korean Patent Application No. 10-2009-0115210, filed with the Korean Intellectual Property Office on Nov. 26, 2009, the disclosure of which is incorporated herein by reference in its entirety.

### BACKGROUND

1. Technical Field

The present invention is related to an ink-jet head.

2. Description of the Related Art

Industrial piezo ink-jet heads have a high nozzle per inch (NPI) structure, which contains a large number of nozzles per unit length, in order to secure high productivity. In this case, as the large number of nozzles are placed adjacent to one another, the interference between jetting cells causes crosstalk. As a result, deviation in jetting properties of the nozzles occurs. Particularly, in the case of utilizing 256 nozzles or 516 nozzles in a single ink-jet head, the crosstalk problem becomes a main factor in deteriorating the jetting of the head at a high frequency. Thus, it is important to eliminate the crosstalk of the head in order to allow the high NPI piezo ink-jet head to eject at a high frequency and to secure high jetting reliability.

Generally, the crosstalk is classified into a fluid crosstalk, which is caused by the transfer of pressure waves through the ink, and a structural crosstalk, in which structural deformation of a reference cell causes a structural change in an adjacent cell. Among them, the fluid crosstalk effect is most common in the high NPI ink-jet head.

### SUMMARY

The present invention provides an ink-jet head that can improve the printing quality by reducing the fluid crosstalk generated inside a common reservoir.

An aspect of the present invention provides an ink-jet head equipped with a plurality of jetting cells, each of which ejects ink. Each of the plurality of jetting cells is connected to a common reservoir supplying the ink, and a pillar is formed inside the common reservoir, in which the pillar supports an upper surface of the common reservoir by being extended from a lower surface to the upper surface of the common reservoir and the pillar disperses a pressure wave transferred inside the common reservoir.

The pillar can be provided as a plurality of pillars. The plurality of pillars can be disposed at regular intervals inside the common reservoir. The plurality of pillars can be arranged in a plurality of rows.

A cross-section of the pillar can be a rhombus, a circle or an ellipse. There can be no separator separating the plurality of jetting cells from one another.

Each of the plurality of jetting cells can include a pressure chamber, which is supplied with ink from the common reservoir, a restrictor, which is interposed between the common reservoir and the pressure chamber, an actuator, which supplies pressure to the pressure chamber, and a nozzle, which ejects the ink by the pressure. Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of an ink jet head in accordance with an embodiment of the present invention.

FIG. 2 shows a plurality of jetting cells connected to a common reservoir.

FIG. 3 shows how a pressure wave is generated in a common reservoir of an ink-jet head.

FIGS. 4A to 4D are plan views illustrating various modifications of pillars of an ink jet head in accordance with an embodiment of the present invention.

FIG. 5 is a plan view illustrating an array structure of pillars of an ink-jet head in accordance with another embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed descriptions of related art are omitted when it is deemed that they may unnecessarily obscure the essence of the invention.

An ink jet head according to certain embodiments of the present invention will be described below in more detail with reference to the accompanying drawings. Those components that are the same or are in correspondence are rendered the same reference numeral regardless of the figure number, and redundant descriptions are omitted.

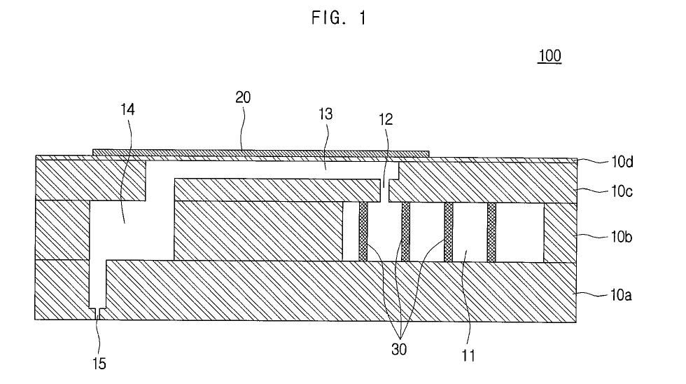

FIG. 1 is a cross-sectional view of an ink-jet head in accordance with an embodiment of the present invention. Illustrated in FIG. 1 are a common reservoir 11, a restrictor 12, a pressure chamber 13, a damper 14, a nozzle 15, an actuator 20, pillars 30, substrates 10a, 10b and 10c and a membrane 10d.

The pressure chamber 13 is where ink is contained, and once pressure is applied by, for example, the actuator 20 using a piezoelectric body formed on an upper surface of the membrane 10d, the ink can be moved in a direction of the nozzle 15 for jetting. A plurality of pressure chambers 13, for example, 128 pressure chambers or 256 pressure chambers, can be disposed in parallel in a single ink-jet head, and there can be a matching number of actuators 20 to the number of pressure chambers 13 in order to provide pressure to each of the plurality of pressure chambers 13.

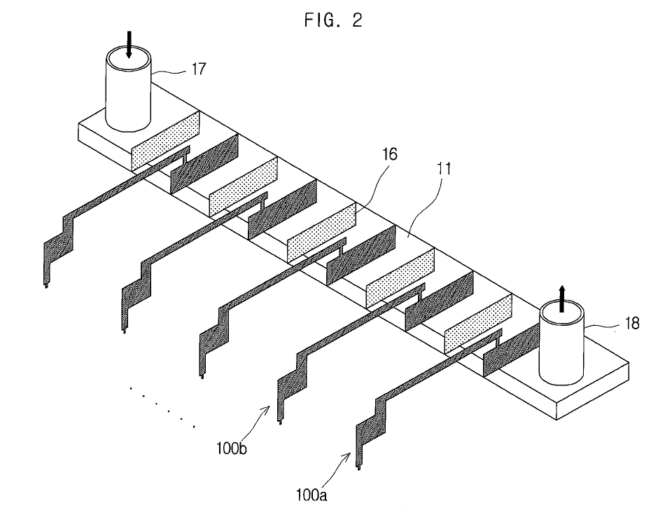

The common reservoir 11 is supplied with ink from the outside through an inlet 17 (shown in FIG. 2), stores the ink, and provides the ink to the pressure chamber 13 described above. Reference numeral 18 shown in FIG. 2 represents an outlet of ink. The pillars 30 for dispersing a transferred pressure wave inside the common reservoir 11 are formed in the common reservoir 11. The pillars 30 have a shape that supports an upper surface of the common reservoir 11 by being extended from a lower surface to the upper surface of the common reservoir 11. Specifically, the pillars 30 connect the substrates 10c and 10a that form the upper and lower surfaces of the common reservoir 11. The functions of the pillars 30 will be described in more detail later.

The restrictor 12 links the common reservoir 11 with the pressure chamber 13 and can function as a channel controlling the flow of ink between the common reservoir 11 and the pressure chamber 13. The restrictor 12 is formed to have a smaller sectional area than those of the common reservoir 11 and the pressure chamber 13 such that the restrictor 12 can control the amount of ink supplied to the pressure chamber 13 from the common reservoir 11 when the membrane 10d is vibrated by the actuator 20.

The nozzle 15 is connected to the pressure chamber 13 and ejects the ink supplied from the pressure chamber 13. When the vibration generated by the actuator 20 is supplied to the pressure chamber 13 through the membrane 10d, pressure can be applied to the pressure chamber 13, causing the nozzle 15 to eject the ink.

The damper 14 is interposed between the pressure chamber 13 and the nozzle 15. The damper 14 can converge the energy generated by the pressure chamber 13 toward the nozzle 15 and dampen a rapid change in pressure.

The above-described components can be formed either by stacking the substrates 10a, 10b and 10c, on which respective components are formed, made of, for example, silicon or ceramic, as illustrated in FIG. 1, or with a single substrate.

FIG. 2 shows a plurality of jetting cells 100a and 100b, each of which is respectively connected to the common reservoir 11. As illustrated in FIG. 2, each of the jetting cells 100a and 100b is equipped with the pressure chamber 13 (shown in FIG. 1), the damper 14 (shown in FIG. 1), the nozzle 15 (shown in FIG. 1) and the restrictor 12 (shown in FIG. 1) and is connected to the common reservoir 11 to be supplied with ink. Also, a separator 16 is disposed in between the jetting cells 100a and 100b to separate the jetting cells 100a and 100b from one another.

While the actuator 20 is operated, ink flows repeatedly inward to and outward from the nozzle 15 and the restrictor 12 at the same time, and this creates positive and negative pressures inside the ink jet head repeatedly. A head portion of a droplet is created by the ink flowing out of the nozzle 15 under the positive pressure, and a neck portion of the droplet is formed by the ink flowing inward to the damper 14 from the nozzle 15 under the negative pressure. The neck portion is where the droplet becomes broken.

Here, it is to be noted that the ink flows repeatedly inward to and outward from the nozzle 15 and the restrictor 12 at the same time. From the perspective of the common reservoir 11, this means that the ink flows inward to and outward from the common reservoir 11 through the restrictor 12, and this repeated flow can change the pressure inside the common reservoir 11. Particularly, if ink is ejected from all of the jetting cells of the ink jet head, more specifically, if pressure waves having a same pattern are generated by, for example, 256 nozzles at the same time, the entire ink inside the common reservoir 11 becomes to pulsate.

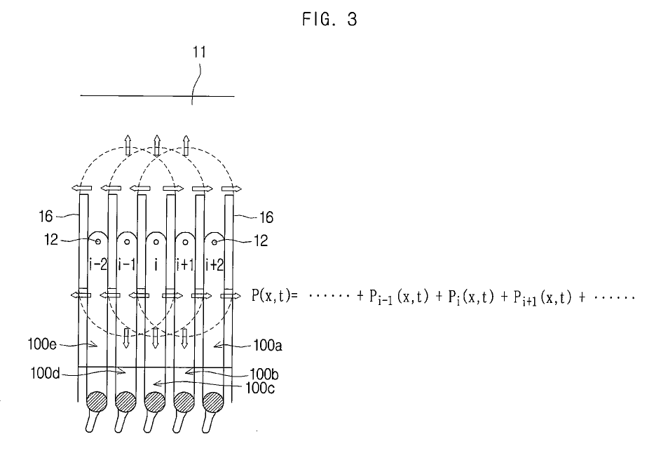

If ink is ejected from the jetting cells 100a, 100b, 100c, 100d and 100e (refer to FIG. 3), the occurrence of ink pulsation creates a difference in pressure between a centrally-located jetting cell and outermost jetting cells, thereby creating a deviation having a specific pattern in size and rate of the ejected droplets between the center and the outermost end.

Furthermore, if ink is ejected from all of the jetting cells 100a, 100b, 100c, 100d and 100e (refer to FIG. 3), the pressure inside the common reservoir 11 is generally increased, and thus the ink can be ejected at a higher rate.

If ink is ejected from every one of the jetting cells 100a, 100b, 100c, 100d and 100e (refer to FIG. 3), periodic inflowing and outflowing of ink are repeated at the restrictor 12, and this periodic behavior generates a pressure wave in the common reservoir 11 of the ink-jet head. This effect is illustrated in FIG. 3. If the pressure generated by an ith jetting cell 100c is Pi(x, t), the change in pressure P(x, t) inside the common reservoir 11 can be expressed as the sum of each Pi(x, t) corresponding to each respective jetting cell. FIG. 3 shows the superposition of pressure through an equation and a drawing.

In this case, a sound wave inside a minute micro-channel, for example, a piezoelectric ink-jet head, gets dispersed quickly. Accordingly, the attenuation of the pressure wave can proceed at a very high speed over time. Therefore, the superposition of pressure waves generated by the jetting cells 100a, 100b, 100c, 100d and 100e (refer to FIG. 3) generates constant pressure distribution inside the common reservoir 11, causing a deviation in the size and rate of droplets being ejected from jetting cells in the center and at an outermost end.

Provided by the present embodiment to solve this problem is a structure in which generation of pressure waves inside the common reservoir 11 is minimized and dispersion of the generated pressure waves is promoted. As illustrated in FIG. 3, the pressure wave generated by each jetting cell is propagated in both directions along the common reservoir 11. At this time, the pressure waves can be superpositioned inside the common reservoir 11, thereby increasing the magnitude.

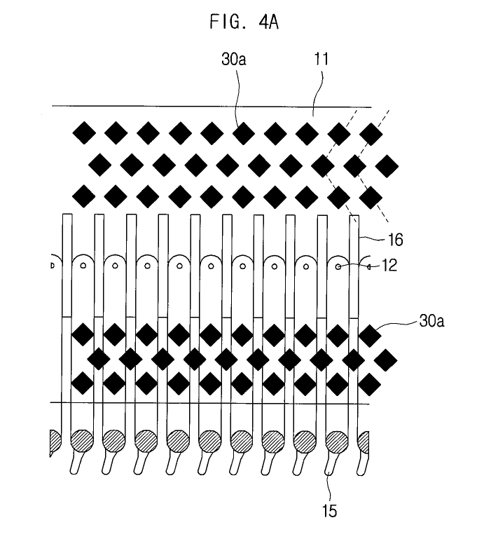

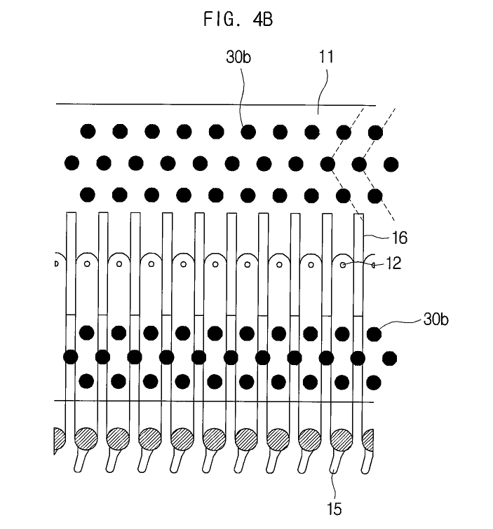

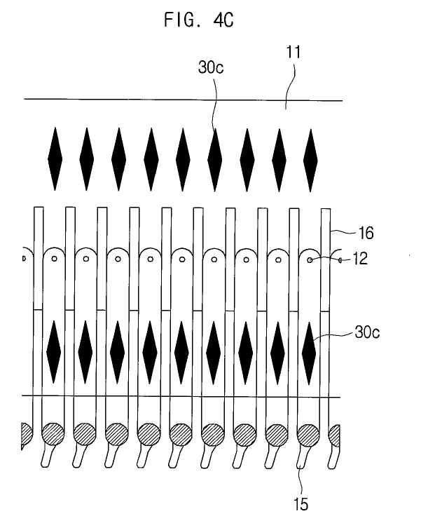

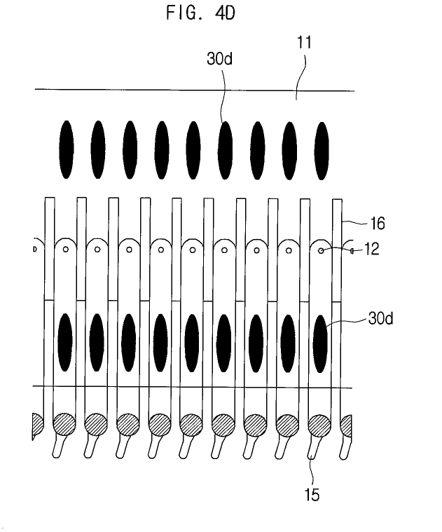

As illustrated in FIGS. 4A to 4D, provided by the present embodiment is an ink jet head in which pillars 30a, 30b, 30c and 30d for dispersing the pressure waves inside the common reservoir 11 are formed in order to prevent the growth of pressure amplitude through the superposition of the pressure waves.

These pillars 30a, 30b, 30c and 30d support the upper surface of the common reservoir 11 by being extended from the lower surface to the upper surface of the common reservoir 11. Specifically, the pillars 30a, 30b, 30c and 30d connect the substrates 10c and 10b forming the upper and lower surfaces of the common reservoir 11. Through this structure, the pillars 30a, 30b, 30c and 30d can function as a supporting body inside the ink jet head, and thus some advantageous effects in obtaining the reliability of the ink-jet head can be expected.

In FIG. 4A, pillars 30a having a cross-section of a rhombus are provided. In FIG. 4B, pillars 30b having a cross-section of a circle are provided. The width of the pillars 30a and 30b can be about ⅓ to ½ of the space between the jetting cells, and the pillars 30a and 30b can be arranged in a plurality of rows. Here, as illustrated in FIGS. 4A and 4B, gaps between the pillars 30a and 30b of one row can be arranged to alternate with gaps between the pillars 30a and 30b of a next row. In this case, the pressure wave generated by each jetting cell can be dispersed when the pressure wave meets the plurality of pillars 30a and 30b, thereby minimizing the growth of the pressure wave inside the common reservoir 11. Moreover, a plurality of pillars can be disposed at regular intervals inside the common reservoir 11 for dispersing the pressure wave more efficiently.

In FIGS. 4C and 4D, one rhombus-shaped or ellipse-shaped pillar 30c and 30d is provided for each single jetting cell.

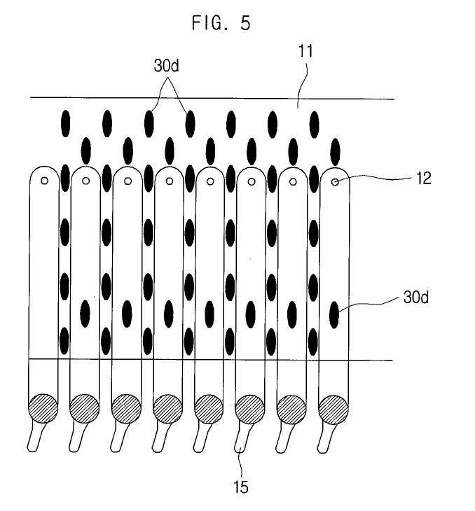

In FIG. 5, the separator 16 (shown in FIG. 3) is omitted, and the pillars 30d for dispersing the pressure wave are disposed in the position of the separator 16. This is because the separator 16 may amplify the pressure wave generated by ink flowing periodically inward to and outward from the restrictor 12. Accordingly, the separator 16 can be removed, and the pillars 30d can be disposed in the position of the separator 16 at regular intervals.

Although the ellipse-shaped pillars 30d illustrated in FIG. 4D are illustrated in FIG. 5, it is also possible that pillars of any other shape can be employed.

By utilizing certain embodiments of the present invention as set forth above, fluid crosstalk generated through a common channel in a piezoelectric ink-jet head using a common reservoir can be quickly dispersed to prevent the growth of pressure waves inside the common reservoir. As a result, deviation in the size and rate of droplets being ejected from jetting cells by the crosstalk can be minimized. Moreover, by minimizing the crosstalk effect, more stable jetting of ink can be possible.

While the spirit of the present invention has been described in detail with reference to particular embodiments, the embodiments are for illustrative purposes only and shall not limit the present invention. It is to be appreciated that those skilled in the art can change or modify the embodiments without departing from the scope and spirit of the present invention.

As such, many embodiments other than those set forth above can be found in the appended claims.

What is claimed is:

1. An ink-jet head equipped with a plurality of jetting cells, each of which ejects ink, wherein:
each of the plurality of jetting cells is connected to a common reservoir configured to supply the ink; and
a pillar is formed inside the common reservoir, the pillar supporting an upper surface of the common reservoir by being extended from a lower surface to the upper surface of the common reservoir, the pillar configured to disperse a pressure wave transferred inside the common reservoir.

2. The ink jet head of claim 1, wherein the pillar is provided as a plurality of pillars.

3. The ink jet head of claim 2, wherein the plurality of pillars are disposed at regular intervals inside the common reservoir.

4. The ink-jet head of claim 2, wherein the plurality of pillars are arranged in a plurality of rows.

5. The ink-jet head of claim 1, wherein a cross-section of the pillar is a rhombus, a circle or an ellipse.

6. The ink-jet head of claim 1, wherein there is no separator separating the plurality of jetting cells from one another.

7. The ink-jet head of claim 1, wherein each of the plurality of jetting cells comprises:
a pressure chamber configured to be supplied with ink from the common reservoir;
a restrictor interposed between the common reservoir and the pressure chamber;
an actuator configured to supply pressure to the pressure chamber; and
a nozzle configured to eject the ink by the pressure.
